(19) United States
(12) Patent Application Publication
(10) Pub. No.: US 2022/0289635 A1
(43) Pub. Date: Sep. 15, 2022

(54) METHOD FOR PREPARING CARBON/BORON CARBIDE COMPOSITE MATERIAL

(71) Applicant: NATIONAL CHUNG SHAN INSTITUTE OF SCIENCE AND TECHNOLOGY, Taoyuan City (TW)

(72) Inventors: YEN-CHUNG CHEN, Taoyuan County (TW); SHANG-WANQ YEH, Taoyuan City (TW)

(21) Appl. No.: 17/197,059

(22) Filed: Mar. 10, 2021

(51) Int. Cl. C04B 35/80; C04B 35/626; C04B 35/64; C04B 35/634; B28B 1/24; B28B 11/24

(52) U.S. Cl. CPC C04B 35/80; C04B 35/6261; C04B 35/62695; C04B 35/64; C04B 35/634; B28B 1/24; B28B 11/243; C04B 2235/5248; C04B 2235/3821; C04B 2235/424; C04B 2235/6022; C04B 2235/661; C04B 2235/6567; C04B 2235/6581; C04B 2235/6582

(57) ABSTRACT

A method for preparing a carbon/boron carbide composite material includes the following steps (A) providing a carbon compound, a carbon fiber, a boron compound and a binder to perform a pretreatment mixing procedure to form a precursor; (B) putting the precursor into a spray granulator for performing a granulation process and mixing the precursor to form an injection material with a uniform composition; (C) feeding the injection material into an injection molding machine for performing a compression molding process, thereby forming a carbon compound/boron compound green body; and (D) subjecting the carbon compound/boron compound green body to a two-stage heat treatment process to obtain the carbon/boron carbide composite material.

### BACKGROUND OF THE INVENTION

### 1. Field of the Invention

The present disclosure relates to a method for preparing a carbon/boron carbide composite material, and in particular to a method for preparing a carbon/boron carbide composite ceramic.

### 2. Description of the Related Art

Carbon/boron carbide composite materials are ceramic materials with light weight and high hardness. The hardness of boron carbide is second only to diamond and cubic boron nitride in nature, especially near constant hardness at high temperature (>30 GPa). In boron carbide, boron and carbon are mainly combined by covalent bonds, which have the characteristics of high melting point (2450 t), high hardness, low density (2.52 g/cm³), good wear resistance, and strong acid and alkali resistance, but pure boron carbide itself has the disadvantages of low fracture toughness, high sintering temperature, and poor stability to metals. With the development of carbon/composite ceramic technology, special sintering of carbon/boron carbide composite ceramics has become possible. Important application aspects of carbon/boron carbide composite ceramic materials include: brake discs, bearings, lightweight machine exoskeleton, thermocouples and arm or ceramics, etc.

The preparation methods of traditional carbon/silicon carbide composite ceramics mainly include hot pressing sintering method, precursor conversion method, chemical vapor synthesis method and reaction melting method. The hot-pressing sintering method has complex equipment, low production efficiency and high cost. The chemical vapor method has a long production cycle, high cost, and many residual pores, which make the prepared carbon/silicon carbide composite ceramic have poor mechanical properties and oxidation resistance. The reaction melting method has a short preparation cycle and low cost, and is the most potential preparation method. However, such a method will produce too much free silicon, destroy the structure of carbon fiber, make the performance of carbon/silicon carbide composite ceramics worse, and destroy the structure of carbon fiber, resulting in deteriorated performance of carbon/silicon carbide composite ceramics.

Therefore, how to prepare a carbon/boron carbide composite ceramic with low cost, high strength, light weight, and high thermal shock resistance, suitable for industrial production, is an urgent problem to be solved.

### BRIEF SUMMARY OF THE INVENTION

In view of the shortcomings of the conventional technologies described above, a main object of the present invention is to provide a method for preparing a carbon/boron carbide composite material, which has simple operation and high production efficiency, thus suitable for industrial production.

Another object of the present invention lies in that the carbon/boron carbide composite material prepared by the method of the present invention has the advantages of low raw material cost, high strength, light weight, high toughness and good friction and wear performance.

A further object of the present invention lies in that compared with the brake disc products made of common brake materials, the carbon/boron carbide composite material prepared by the method of the present invention for use in brake materials has about 60% reduction in weight, can withstand 1000° C. high temperature, and is corrosion resistant and lightweight such that it is considered to be the most promising new generation of high-strength, lightweight and wear-resistant composite material.

To achieve the objects described above, the present invention provides a method for preparing a carbon/boron carbide composite material, which comprises the following steps: (A) providing a carbon compound, a carbon fiber, a boron compound and a binder to perform a pretreatment mixing procedure to form a precursor; (B) putting the precursor into a spray granulator for performing a granulation process and mixing the precursor to form an injection material with a uniform composition; (C) feeding the injection material into an injection molding machine for performing a compression molding process, thereby forming a carbon compound/boron compound green body; and (D) subjecting the carbon compound/boron compound green body to a two-stage heat treatment process to obtain the carbon/boron carbide composite material.

With respect to the method for preparing a carbon/boron carbide composite material proposed by the present invention, in the pretreatment mixing procedure, the weight percentage of each component of the carbon compound, the carbon fiber, the boron compound, and the binder is 1 wt % to 10 wt % for the carbon compound, 1 wt % to 20 wt % for the carbon fiber, 40 wt % to 70 wt % for the boron compound and 5 wt % to 35 wt % for the binder.

With respect to the method for preparing a carbon/boron carbide composite material proposed by the present invention, the carbon compound is selected from the group consisting of graphene, carbon black and activated carbon.

With respect to the method for preparing a carbon/boron carbide composite material proposed by the present invention, the boron compound is selected from the group consisting of h-boron nitride, boron oxide, diborane and trialkylborane, wherein the h-boron nitride has a hexagonal boron nitride structure.

With respect to the method for preparing a carbon/boron carbide composite material proposed by the present invention, the binder is selected from the group consisting of asphalt, polyvinylpyrrolidone, polypropylene, a polyvinyl alcohol and a silane coupling agent.

With respect to the method for preparing a carbon/boron carbide composite material proposed by the present invention, the pretreatment mixing procedure mixes the carbon compound, the carbon fiber, the boron compound and the binder by ball milling, and a mixing time of the ball milling is between 1 to 4 hours.

With respect to the method for preparing a carbon/boron carbide composite material proposed by the present invention, in step (B), an inlet temperature of the spray granulator is greater than or equal to 200° C., and an outlet temperature of the spray granulator is greater than or equal to 100° C.

With respect to the method for preparing a carbon/boron carbide composite material proposed by the present invention, a pressure of the injection molding machine in step (C) is greater than or equal to 130 kgf, and a temperature of the injection molding machine is between 150° C. and 250° C.

With respect to the method for preparing a carbon/boron carbide composite material proposed by the present invention, the two-stage heat treatment process of step D includes a first-stage vacuum heat treatment and a second-stage atmosphere heat treatment, wherein a temperature of the first-stage vacuum heat treatment is greater than or equal to 1000° C., a calcination time of the first-stage vacuum heat treatment is at least 1 hour, a temperature of the second-stage atmosphere heat treatment is greater than or equal to 1900° C., and a calcination time of the second-stage atmosphere heat treatment is at least 2 hours.

With respect to the method for preparing a carbon/boron carbide composite material proposed by the present invention, the first-stage vacuum heat treatment uses a high frequency calciner or a vacuum calciner.

With respect to the method for preparing a carbon/boron carbide composite material proposed by the present invention, a noble gas is introduced in the second-stage atmosphere heat treatment, and the noble gas is selected from the group consisting of argon, helium and hydrogen.

The above summary and the following detailed description and drawings are all for the purpose of further explaining the methods, means and effects adopted by the present invention to achieve the intended objects. The other objects and advantages of the present invention will be set forth in the subsequent descriptions and drawings.

### BRIEF DESCRIPTION OF THE DRAWINGS

FIG. 1 is a flow chart showing a preparation method of the carbon/boron carbide composite material according to the present invention.

### DETAILED DESCRIPTION OF THE INVENTION

To facilitate understanding of the object, characteristics and effects of this present disclosure, embodiments together with the attached drawings for the detailed description of the present disclosure are provided.

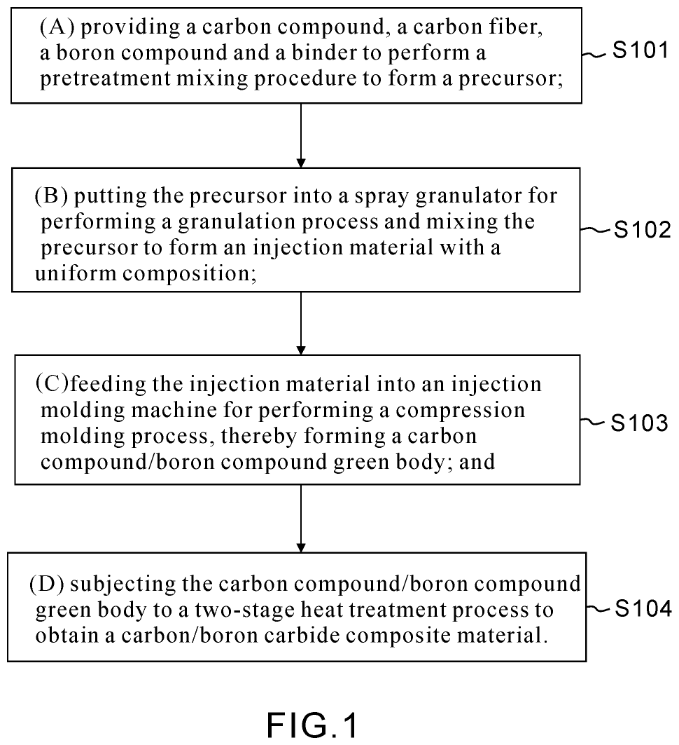

Please refer to FIG. 1, which shows the preparation method of the carbon/boron carbide composite material of the present invention. The steps may include:

(A) providing a carbon compound, a carbon fiber, a boron compound and a binder to perform a pretreatment mixing procedure to form a precursor S101;

(B) putting the precursor into a spray granulator for performing a granulation process and mixing the precursor to form an injection material with a uniform composition S102;

(C) feeding the injection material into an injection molding machine for performing a compression molding process, thereby forming a carbon compound/boron compound green body S103;

(D) subjecting the carbon compound/boron compound green body to a two-stage heat treatment process to obtain a carbon/boron carbide composite material S104.

The embodiment of the preparation method proposed by the present invention provides a method for preparing a carbon/boron carbide composite material. The method may include the following steps. Step (A): 1 wt % to 10 wt % carbon compound, 1 wt % % to 20 wt % carbon fiber, 40 wt % to 70 wt % boron compound and 5 wt % to 35 wt % binder are mixed by ball-milling for 1 to 4 hours to form a carbon compound/boron compound precursor. In this embodiment, the boron compound can be h-boron nitride, boron oxide, diborane or trialkylborane. The binder can be asphalt, polyvinylpyrrolidone, polypropylene, a polyvinyl alcohol, a silane coupling agent or a combination thereof, preferably asphalt. The carbon fiber is formed by carbonization and graphitization of polymer fibers or pitch-based materials, has a carbon content of more than 80% and has the advantages of high specific strength, large specific modulus, good high temperature mechanical properties and good thermal properties. The carbon powder may be graphene, carbon black or activated carbon or a combination thereof. Step (B): The precursor from step (A) is put into a spray granulator and mixed to form an injection material of uniform composition. The inlet temperature of the spray granulator is set to be greater than or equal to 220 degrees, and the outlet temperature is set to be greater than or equal to 100 degrees. Step (C): The injection material from step (B) is fed into a ceramic injection molding machine for pressure molding to the required model size to form carbon compound/boron compound green body. The parameters of the injection molding machine are set as what follows. The pressure is set to be greater than or equal to 130 kgf, and the temperature is set to be between 150° C. and 250° C. Step (D): The carbon compound/boron compound green body is subject to vacuum sintering at a temperature greater than or equal to 1000° C. for a calcination time of at least 1 hour, followed by atmosphere calcination at a temperature greater than or equal to 1900° C. for a calcination time of at least 2 hours to convert the carbon compound/boron compound into the boron carbide crystal phase and obtain a carbon/boron carbide composite ceramic, thereby promoting better bonding strength.

In the embodiment of the present invention, the pressure of the injection molding machine can also be between 130-250 kgf.

In the embodiment of the present invention, the inlet temperature of the spray granulator may be between 200-300° C., and the outlet temperature may be between 100-160° C.

In the embodiment of the present invention, the vacuum heat treatment temperature of the carbon compound/boron compound green body can be between 1000° C. and 1200° C., and the calcination time can be between 1-5 hours.

In the embodiment of the present invention, the temperature of the atmosphere calcination may be between 1900-2100° C., and the calcination time may be between 2 and 14 hours.

In the embodiment of the present invention, the heat treatment equipment for vacuum sintering can be a high frequency calciner or a vacuum calciner.

In the embodiment of the present invention, the atmosphere calcination equipment may be an atmosphere calcination furnace, into which the gas introduced is a noble gas, and the noble gas may be one or a combination of argon, helium or hydrogen.

The preparation method of the carbon/boron carbide composite material of the present invention has the following advantages: (1) The present invention is a precursor conversion method that does not directly use boron carbide as the raw material and chemically synthesizes the carbon/boron carbide composite ceramic. Through the granulation process, the precursor can be heated and then rapidly cooled to form a uniform solid injection material. The advantage of granulation is that it can improve the flow and uniformity of traditional injection, and then through atmosphere and vacuum heat treatment, the precursor (carbon boron compound) is converted into boron carbide, the uniformity of cracking reaction is improved, and the cost of raw materials is reduced. (2) The carbon/boron carbide composite material of the present invention has simple operation and low raw material cost, does not use boron carbide as the precursor directly, can improve the density and is suitable for industrial production. The carbon/boron carbide composite material obtained by the preparation method of the present invention has the advantages of high strength, light weight, high toughness, good friction and wear performance and the like.

While the present disclosure has been described by means of specific embodiments, numerous modifications and variations could be made thereto by those skilled in the art without departing from the scope and spirit of the present disclosure set forth in the claims.

What is claimed is:

1. A method for preparing a carbon/boron carbide composite material, comprising:
(A) providing a carbon compound, a carbon fiber, a boron compound and a binder to perform a pretreatment mixing procedure to form a precursor;
(B) putting the precursor into a spray granulator for performing a granulation process and mixing the precursor to form an injection material with a uniform composition;
(C) feeding the injection material into an injection molding machine for performing a compression molding process, thereby forming a carbon compound/boron compound green body; and
(D) subjecting the carbon compound/boron compound green body to a two-stage heat treatment process to obtain the carbon/boron carbide composite material.

2. The method for preparing a carbon/boron carbide composite material of claim 1, wherein in the pretreatment mixing procedure, the weight percentage of each component of the carbon compound, the carbon fiber, the boron compound, and the binder is 1 wt % to 10 wt % for the carbon compound, 1 wt % to 20 wt % for the carbon fiber, 40 wt % to 70 wt % for the boron compound and 5 wt % to 35 wt % for the binder.

3. The method for preparing a carbon/boron carbide composite material of claim 1, wherein the carbon compound is selected from the group consisting of graphene, carbon black and activated carbon.

4. The method for preparing a carbon/boron carbide composite material of claim 1, wherein the boron compound is selected from the group consisting of h-boron nitride, boron oxide, diborane and trialkylborane, wherein the h-boron nitride has a hexagonal boron nitride structure.

5. The method for preparing a carbon/boron carbide composite material of claim 1, wherein the binder is selected from the group consisting of asphalt, polyvinylpyrrolidone, polypropylene, a polyvinyl alcohol and a silane coupling agent.

6. The method for preparing a carbon/boron carbide composite material of claim 1, wherein the pretreatment mixing procedure mixes the carbon compound, the carbon fiber, the boron compound and the binder by ball milling, and a mixing time of the ball milling is between 1 to 4 hours.

7. The method for preparing a carbon/boron carbide composite material of claim 1, wherein in step (B), an inlet temperature of the spray granulator is greater than or equal to 220° C., and an outlet temperature of the spray granulator is greater than or equal to 100° C.

8. The method for preparing a carbon/boron carbide composite material of claim 1, wherein a pressure of the injection molding machine in step (C) is greater than or equal to 130 kgf, and a temperature of the injection molding machine is between 150° C. and 250° C.

9. The method for preparing a carbon/boron carbide composite material of claim 1, wherein the two-stage heat treatment process of step D includes a first-stage vacuum heat treatment and a second-stage atmosphere heat treatment, wherein a temperature of the first-stage vacuum heat treatment is greater than or equal to 1000° C., a calcination time of the first-stage vacuum heat treatment is at least 1 hour, a temperature of the second-stage atmosphere heat treatment is greater than or equal to 1900° C., and a calcination time of the second-stage atmosphere heat treatment is at least 2 hours.

10. The method for preparing a carbon/boron carbide composite material of claim 9, wherein the first-stage vacuum heat treatment uses a high frequency calciner or a vacuum calciner.

11. The method for preparing a carbon/boron carbide composite material of claim 9, wherein a noble gas is introduced in the second-stage atmosphere heat treatment, and the noble gas is selected from the group consisting of argon, helium and hydrogen.
